(19) United States
(12) Patent Application Publication
(10) Pub. No.: US 2016/0086293 A1
(43) Pub. Date: Mar. 24, 2016

(54) HUMAN-COMPUTER COLLABORATION FOR TRAVEL PLANNING

(71) Applicant: Inspirock, Inc., Palo Alto, CA (US)

(72) Inventor: Prakash Sikchi, Palo Alto, CA (US)

(21) Appl. No.: 14/862,028

(22) Filed: Sep. 22, 2015

Related U.S. Application Data
(60) Provisional application No. 62/053,734, filed on Sep. 22, 2014.

(51) Int. Cl. G06Q 50/14; G06Q 30/06; G06Q 10/02

(52) U.S. Cl. CPC G06Q 50/14; G06Q 10/02; G06Q 30/0613; G06Q 30/0631

(57) ABSTRACT

Human computer collaboration may be used to generate an optimal travel plan. The collaboration may include receiving a user input that includes a travel plan at a computing device. A knowledge base is further queried based at least on a query that includes the user input. A plurality of seeds comprising a high level sketch of a candidate travel plan is then generated. Multiple seeds of the plurality of seeds that satisfy the query are selected. The multiple selected seeds are further ranked to generate multiple ranked seeds. The multiple ranked seeds are optimized to generate multiple optimized seeds, which are ranked such that at least one of the multiple optimized seeds is surfaced as a travel plan.

### CROSS REFERENCE TO RELATED PATENT APPLICATION

This patent application claims priority from U.S. Provisional Application No. 62/053,734, filed Sep. 22, 2014, which application is hereby incorporated in its entirety by reference.

### BACKGROUND

There are many real-life situations that are best solved by humans and computers collaborating with each other. As computers become more capable, the mode of interaction between humans and computers should evolve and adapt, since the existing modes of interaction are not able to fully harness what computers are capable of. These existing modes can be described as a master-slave relationship between the human and the computer. The existing modes of interactions fail to give sufficient autonomy to computers, which limit their ability to contribute.

An example problem in travel planning is a user who wants to plan a family vacation, including figuring out what destinations to visit, how many days to spend in each destination, what activities to do in each day, and logistics such as traveling, scheduling, etc.

In this example, the Profile may contain information about the user and travelers, their past vacations, and their social graph. The Requirements could be “I want to go with my family of 2 adults and 2 children to Spain and Italy, starting on August 1st and coming back on August 14th”, or “don't schedule anything on Sunday between 3 pm and 6 pm”. The Explicit Preferences could be “I want to do an active vacation, I prefer outdoors, I am interested in culture, but not in nightlife or museums”.

### BRIEF DESCRIPTION OF THE DRAWINGS

The Detailed Description is set forth with reference to the accompanying figures:

FIG. 1 is an overview of the system.

FIG. 2 is a flow chart depicting the behavior of the Agent.

### DETAILED DESCRIPTION

### Context—Human Computer Collaboration

The elements of the disclosed system include:
1. An intelligent Agent that can collaborate well with the User.
2. A shared workspace that allows the User and the Agent to iterate on both the problem and the solution.
3. A domain-specific Knowledge Base that the Agent can query.

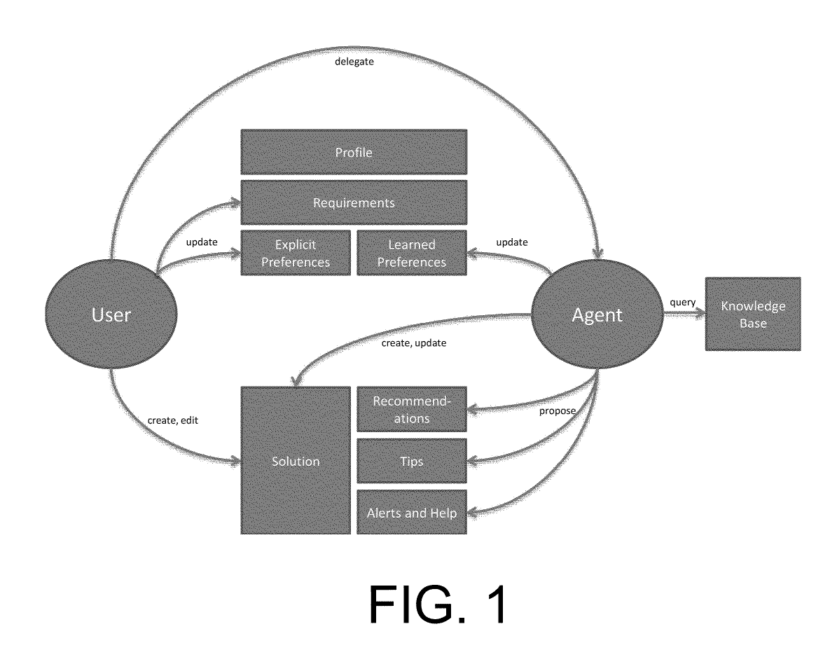

FIG. 1. is an overview of the system:

The components of the system are described in more detail below:

### User

1. The User owns the Problem definition, as described by Requirements and Preferences.
2. The User controls when to delegate the problem to the Agent and whether to delegate the entire problem or some part of it.
3. The User can either create the initial Solution to the Problem or ask the Agent to create it.
4. The User can edit the Solution or the Problem at any time.

### Agent

1. The Agent's role is to understand the Problem definition (including User's Profile and Learned Preferences) and to provide a Solution.
2. In addition, the Agent can propose Recommendations, Tips, and Alerts to help the User.
3. The Agent has the ability to solve either the entire Problem or any part of it.
4. The Agent has the ability to work autonomously, with the level of autonomy controlled by the User.
5. The Agent that can come up with a best-attempt solution(s) when no solution exists.
6. The Agent can query a domain-specific Knowledge Base for domain expertise.
7. The Agent can observe User's actions and learn the User's preferences (Learned Preferences).

### Shared Workspace

1. The Shared Workspace has two groups of entities—Problem Group and Solution Group.
2. The Problem Group consists of the User's Profile, Requirements, Explicit Preferences and Learned Preferences.
   a. The Profile contains information about the user that can be used to infer Learned Preferences.
   b. The Requirements are specified by the User and define the must-have characteristics of the Solution.
   c. The Explicit Preferences are specified by the User and define the desirable characteristics of the Solution.
   d. The Learned Preferences are created and updated by the Agent based on all the information at the Agent's disposal including observing the User's actions.
3. The Solution Group consists of the Solution, Recommendations, Tips, and Alerts.
   a. The Solution is the latest “in-progress” attempt at solving the Problem. An ideal Solution would meet all the Requirements and Preferences (both Explicit and Learned). When there are multiple solutions possible, the Solution represents the “active” one that is being collaborated on. It is possible that the Solution does not meet all the Requirements. The Solution can be created and edited by either the User or the Agent, either in full or in part.
   b. The Recommendations are alternatives to the Solution. These are created and updated by the Agent to help the user understand alternative approaches to solving the Problem.
   c. The Tips are information that can help the User make choices. These are created and updated by the Agent.
   d. The Alerts correspond to deficiencies in the Solution (to better satisfy Requirements) or opportunities for improvement in the Solution (to better satisfy Preferences). These are created and updated by the Agent. The Alerts may also be associated with guidance on how to fix the deficiencies in the Solution or improve the Solution.

### Knowledge Base

The Knowledge Base is domain-specific and is provides all the knowledge the Agent needs to understand the Problem Group, and to create the Solution, learn preferences and to make proposals. A typical Knowledge Base would contain a query-able model of the domain, synthesized from a variety of sources, and inferences on that model. Typically this would be built by large-scale data gathering, collating, mining, and learning.

### The Travel Planning Problem

This section describes how the implementation works for the Travel Planning domain.

An example problem in travel planning is a user who wants to plan a family vacation, including figuring out what destinations to visit, how many days to spend in each destination, what activities to do in each day, and logistics such as traveling, scheduling, etc.

In this example, the Profile may contain information about the user and travelers, their past vacations, and their social graph.

The Requirements could be “I want to go with my family of 2 adults and 2 children to Spain and Italy, starting on August 1st and coming back on August 14th”, or “don't schedule anything on Sunday between 3 pm and 6 pm”.

The Explicit Preferences could be “I want to do an active vacation, I prefer outdoors, I am interested in culture, but not in nightlife or museums”.

A Solution created by the system may include:
1. A list of destinations to visit, including how many days to spend in each destination, how to get from one destination to another, etc.
2. A detailed itinerary for each day of the vacation showing what activities to do when, in what sequence, how much time to spend at each activity, and how to get from one activity to another. Activities can be of several types—visiting a point of interest, going on a tour, or dining at a restaurant, etc. are all considered activities.
3. Other information relevant to understanding the plan such as maps, photographs, reviews and opinions, text description, pricing information, business hours, etc.

The Recommendations may include alternate destinations to consider visiting (e.g. Granada instead of Seville), or alternate activities to consider for any day in the plan (e.g. Piazza Navona instead of the Pantheon). The Recommendations may also include opportunities for improving the Solution. For example, if the user edits the route to be Rome→Barcelona→Madrid→Venice→Florence, the Agent may recommend a different route (e.g. Rome→Florence→Venice→Barcelona→Madrid) instead.

Examples of Tips are: what is a reasonable amount of time to spend at the Sistine Chapel, what is the average cost of a hotel in a Rome, and how to find the right location to stay in Madrid.

Examples of Alerts would be calling out that the user has scheduled a visit to the Sagrada Familia at 8.30 am, but it opens at 9.00 am on that day, or that the user has allocated only 30 minutes to get from the Cathedral of Toledo to the Royal Palace of Aranjuez, and it takes about 45 minutes instead. Associated with these Alerts would be suggestions on how to fix the plan to avoid the problems (e.g. edit the schedule), or offer to recalculate the plan which would fix the problem automatically.

Examples of autonomous actions in the system are the Agent recalculating the Itinerary for Venice if the user adjusts the number of days they want to be in Venice, or updating the schedule if the user adds an activity to their plan.

The user can ask the system to calculate an entire plan based on their requirements, or they can ask the system to recalculate the itinerary for a particular destination.

As the user makes edits to the plan, browses recommendations, or otherwise uses the system, the Agent may learn that the user is interested in going to Park Güell but not to Camp Nou, or that the user is interested in water sports but not beaches.

### Unique Characteristics

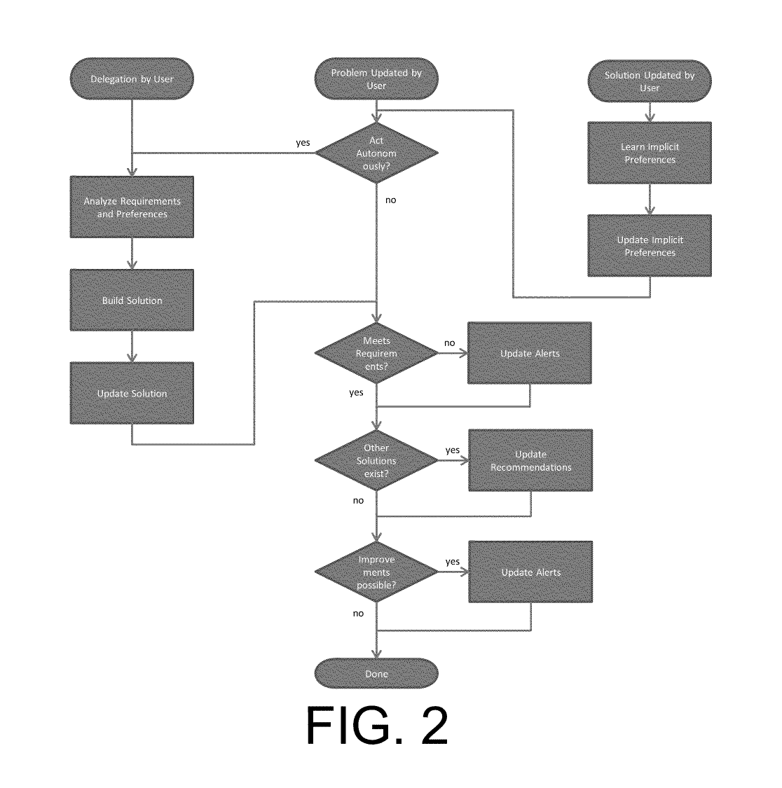

The problem of maximizing some function (e.g. expected fun a traveler would have) subject to spatio-temporal constraints occurs in other domains. However, there are a number of characteristics that are unique to Travel Planning.
1. Users have a wide variety of needs and the range of plans required to satisfy the user is large:
   a. The scope of the plan can vary a lot. Plans may be limited to a City, or to a Region, or they may span one or more Countries.
   b. Some plans start and end at the same destination, whereas some plans start at one destination and end at another.
   c. Some plans may incorporate side-trips (mini-plans). A plan that involves staying at San Francisco for a few days may involve visiting Napa Valley for a day.
2. Combination of hard Requirements and fuzzy Preferences.
   a. Requirements are hard constraints (e.g. travelling to France and Germany from 1st September through 15th September).
   b. Preferences are soft constraints (e.g. prefer to see some hidden gems, don't want to see the Eiffel Tower, want to spend 3 hours at the Notre Dame Cathedral).
   c. Diversity is implicitly included as a preference. For example, even though the user prefers to see museums, a vacation plan that comprises entirely of visits to museums is not desirable. And even though Paris may have the best museums, a vacation plan for several days with all of them in Paris may not be desirable.
3. Users don't typically specify all their preferences up front. They may not even know all their preferences until they are presented with decisions they need to make. This means arriving at a satisfactory plan is an iterative process requiring multiple exploratory interactions from the user. This imposes strong requirements on the performance of the system. The solutions need to be built in a few seconds.
4. A consequence of the above is that the system needs to continuously observe the user actions and learn the user's implicit preferences (Learned Preferences).
5. The Agent needs to make plans even with incomplete information. FIG. 2 depicts the behavior of the Agent. The user may not have decided whether they want to fly from one destination to another or to take the train. They may not have decided whether they are going to walk from one activity to another or take public transport. They may not have decided where they are staying. The solution needs to make intelligent guesses to fill in such information and produce a plan, and allow the plan to be updated when the information is finally made available.

### Knowledge Base

### Implementation

1. Knowledge Base contains multiple entity types, such as Activity, Destination, and Route. It may contain 100s of attributes for an entity.
2. This information is assembled from several sources. Heterogeneous Entity Resolution is required to build a coherent set of data.
3. Various inferences are performed on this data. Examples are:
   a) What destinations are suitable for tourists to stay at?
   b) What is a “good” amount of time to spend at a destination?
   c) The expected fun value of an activity.
   d) The primary type(s) of the activity (e.g. beach, museum, etc.).
   e) Whether the activity is suitable for kids.
   f) Whether the activity is a highly-trafficked.
   g) Whether the activity is a hidden gem.
4. The Knowledge Base is cleansed. Suspicious data and inferences are automatically and manually flagged. Data corrections are then applied wherever appropriate.

### Querying

1. Knowledge Base is loaded as a custom-built in-memory graph.
2. Indices are built for fast access, esp. for queries involving radii based on time or distance.

### Building a Plan—Implementation

Building a good travel plan in a short amount of time is computationally intractable. A typical use case may require exploration of trillions of possibilities, while there is enough time to explore only millions of possibilities. To achieve such cardinality reduction of multiple orders of magnitude, we need to solve two mutually interdependent problems—Ranker and Generator.

### Ranker

1. Ranker should be able to rank a travel plan and give it a numeric score which lets us determine the best plan from among a potentially large set of plans.
2. In order to achieve effective cardinality reduction, a Ranker needs to be locally predictable. It should be possible to estimate with sufficiently high accuracy (perfect estimation is not achievable because the problem is too chaotic) the effect of a small change on the overall score.
3. The Ranker should be able to approximate, and should be possible to estimate with sufficiently high accuracy the score of a “high-level sketch” (aka seed) of a plan, or of a partially-built plan.
4. To solve these, our Ranker implementation uses a closed-form expression, which takes various plan characteristics and statistics into account, and computes three components of the score, which are then combined to compute the final score:
a) Sum of Fun of activities in the plan
b) Amount of time spent having fun, estimated as a weighted ratio of amount of time spent having fun to the total time. Intuitively, this component represents the “cost” of a plan.
c) Diversity factor. The higher the concentration (estimated similar to the Herfindahl-Hirschman Index), the lower the diversity in the plan.

### Generator

1. Building an optimal plan requires exploring trillions of possibilities. However, in practice, there is only enough time to explore millions of possibilities. The job of the Generator is to select a very small percentage of possibilities that are most likely to produce the optimal plan.
2. To maximize exploring possible plans that are most likely to result in the best plan in a severely limited amount of time, a multi-stage tournament is used. The earlier stages explore more plans and big changes and are estimated approximately. At the end of each stage, the most promising plans are selected for deeper and more accurate exploration in the next stage.
3. Initial Preparation. Initial Preparation consists of:
   a) Querying the Knowledge Base to find all interesting activities
   b) Querying the Knowledge Base to find all possible destinations from which these activities can be visited.
   c) Querying the Knowledge Base to find the time required to travel from any activity or destination to any other activity or destination.
   d) Inferring the time to be spent at the activity. This takes into account both Explicit and Learned Preferences.
   e) Inferring the fun value of each individual activity.
4. Stage 1: Seed Generation
   a) A seed is a high-level sketch of a plan. It describes an ordered list of destinations to visit and approximately how much time to spend at each destination.
   b) Seeds are generated using statistical information and approximate computation of the fun vs. time curve for each destination.
   c) There are multiple strategies to generate seeds, as there is no strategy that produces the best seeds in all contexts. These strategies are human-inspired—they are developed by observing and analyzing how humans solve these problems.
   d) Using these strategies, base seeds are produced.
   e) Borrowing from Genetic Algorithms, mutations are introduced in these seeds to produce variants of the base seeds.
   f) Seeds are then optimized to minimize travel, both by merging stays at nearby destinations when appropriate, and using Traveling Salesman algorithms to find optimal routes between the destinations. Merging strategies are human-inspired.
   g) Any seeds that don't meet the Requirements are discarded.
   h) Seeds are then scored using the Ranker and the best seeds are selected for Stage 2.
5. Stage 2: Candidate Generation
   a) A Candidate plan is a valid detailed plan. A Candidate plan meets all Requirements, but may not be optimal in terms of meeting all Preferences. It is built quickly, without a lot of computational effort spent on optimizing it.
   b) The Seeds are filled with activities using a quick, greedy-fill strategy to build a Candidate.
   c) Candidates are then scored using the Ranker and the best candidates are selected for Stage 3.
6. Stage 3: Optimization
   a) Candidate plans are optimized to better meet user Preferences. Optimization is very expensive and can only be done on a small number of Candidates.
   b) Typically there is some commonality among Candidates. For example, consider the following Candidates:
      i. Candidate 1: Paris (1st-3rd September), Rouen (4th September), Rome (5th-9th September)
      ii. Candidate 2: Paris (1st-3rd September), Rouen (4th September), Nice (5th-9th September)
      iii. Candidate 3: London (1st September), Paris (2nd-4th September), Rome (5th-9th September)
      iv. Candidate 4: Paris (1st-3rd September), Versailles (4th September), Nice (5th-9th September)
      In this example, the following commonality can be exploited:
      i. “Paris (1st-3rd September), Rouen (4th September)” can be shared between Candidate 1 and Candidate 2.
      ii. “Rome (5th-9th September)” can be shared between Candidate 1 and Candidate 3.
      iii. “Nice (5th-9th September)” can be shared between Candidate 2 and Candidate 4.
   c) Borrowing techniques from Dynamic Programming, the Candidates are analyzed and divided into the smallest possible fragments that can be optimized independently. The fragments from all Candidates are de-duped and each fragment is optimized.
   d) Optimization is done using multiple rounds of Simulated Annealing. Conventional Simulated Annealing works best on small/local perturbations. This is too slow. In order to speed it up, we leverage that our Ranker is approximatable and use big/non-local perturbations that have a high probability of exploring optimal solutions.
   e) Fragments are reassembled into plans. All Candidate plans are scored and the best plan is selected.

### Tuning

Finally, the system needs significant tuning to simultaneously ensure that:
1. The Generator is spending most of its time exploring possibilities that the Ranker will score highly.
2. The Ranker is producing scores that correlate highly with expert judgment.
3. The Ranker is approximatable.

This is achieved through a combination of automated and manual exploration of the configuration space, and automated and manual analysis of non-optimal plans.

### Example Use Case—Multi-Destination/Multi-Country Trips

As previously mentioned, the system optimizes trip planning by generating a large number of seeds representing variations on candidate trip plans, and then ranks the generated seeds and selects the optimal candidate trip plan as a recommendation. However, the more complex the trip, the more parameters there are to permute, and the more seeds are generated. The system has an additional optimization where low priority seeds are pruned early in the process, as a result, the system is faster than prior art trip planners, and can timely provide a trip plan for complex scenarios.

One use case that is such a complex scenario is multi-destination/multi-country trip planning. The system will support the following functionality:
1. Ability to build a plan that includes multiple destinations spanning any arbitrary geographical area of interest. Specifically, the user can specify one or more cities and/or one or more regions and/or one or more countries, and the system can build a plan that meets those requirements. If any cities are explicitly specified, then they are included in the plan. If regions and/or countries are specified, then the system will automatically pick that combination of destinations to visit that will result in the best plan for the user. For example, if the user wants to go to Paris, Loire Valley, and Italy for 16 days, the generated plan could be: Paris: 4 days, Amboise: 1 day, Venice: 3 days, Florence: 2 days, Rome: 4 days, Naples: 2 days.
2. Ability to calculate the best combination of taking side-trips and staying at destinations. For example, if the user wants to spend 4 days in British Columbia, the system may build a plan that requires staying in Vancouver for 4 days, and on one of the days, taking a side-trip to visit Victoria. On the other hand if the user wants to spend 7 days in British Columbia, the system may build a plan that requires staying 5 days in Vancouver and 2 days in Victoria. Ability to explore such side-trip possibilities and build the best plan for the user is unique to our system.
3. The system can track additions/deletions and duration-adjustments to activities in the plan, learn implicit preferences such as “user wants to see Tivoli Gardens”, “user does not want to see the Coliseum”, “user wants to spend 2 hours at the Sistine Chapel”, etc. These preferences are then used to improve the Plan, Recommendations, Tips, and Alerts. When all such preferences cannot be satisfied (e.g. user wants to do many activities but there isn't enough time), then the system can intelligently figure out which preferences to satisfy and which preferences to skip in order to come up with the best plan for the user.

### Extensions to the Base System

1. Budget constraint either as a Requirement or a Preference.
2. Multiple users with different roles collaborating in the Shared Workspace (e.g. Owner, Traveler, Friend, Reader, Travel Agent, etc.)
3. Ability to book all or part of a plan. There can be several ways of booking
   a. User shops for and books individual components of the plan
   b. User shops for and books the entire package from a travel provider
   c. User requests a travel agent to help with booking individual components of the plan
   d. User requests a travel agent to help with booking the entire plan
   e. User is connected with suitable travel agents who can help book the plan (in part or in full)
4. Ability to dynamically assemble a plan based on available inventory of travel products in the Knowledge Base.
5. Ability for the Agent to continue collaborating with the User as they are travelling Agent can track the User's actual travel and compare that with the User's intended plan to provide better Solutions and Proposals.
6. Letting the User augment the Knowledge Base to help with their Solution (e.g. adding information about a restaurant they want to dine at).
7. Multiple Agents (multiple domains of expertise).
8. Multiple Solutions in the workspace being explored and compared.

### CONCLUSION

Although the subject matter has been described in language specific to structural features and/or methodological acts, it is to be understood that the subject matter defined in the appended claims is not necessarily limited the specific features or acts described above. Rather, the specific features and acts described above are disclosed as example forms of implementing the claims.

What is claimed is:

1. A system for providing recommendations to a user, comprising:
one or more processors;
memory storing components that are executable by the one or more processors, the components comprising:
a business logic component communicatively coupled to a client application, the business logic component including a ranker component and a generator component communicatively coupled to the ranker component,
a knowledge base communicatively coupled to the business logic component,
wherein the generator component provides a solution to a user by working iteratively with the ranker component to select a predetermined percentage of possibilities based at least on the knowledge base and one or more partial requirements and at least one preference specified by the user.

2. The system of claim 1, wherein the client application further comprises an agent, the agent to:
process a problem definition of a problem to provide the solution, the problem definition including a user profile of the user and the at least one preference specified by the user;
propose recommendations, tips, and alerts associated with the solution to assist the user;
solve at least one portion of the problem defined by the problem solution, wherein the solution is a partial solution to the at least one portion of the problem,
work autonomously based on a level of autonomy specified by the user;
generate a solution that is a best-attempt solution in response to determining that no other solutions exist;
query a domain-specific knowledge base for domain expertise; and
observe user actions of the user to learn the preferences of the user.

3. The system of claim 2, wherein the knowledge base provides knowledge that is used by the agent to understand a problem group, create the solution, learn the preferences, and make proposals.

4. The system of claim 2, wherein the client application further provides a shared workspace that enables the user and the agent of the client application to iterate on a problem defined by a problem definition and the solution.

5. The system of claim 3, wherein the shared workspace further comprises a problem group and a solution group.

6. The system of claim 1, wherein the business logic component resides in a first portion of the memory that is provided by a computing device that is remote from an additional computing device that provides a second portion of the memory that stores the knowledge base.

7. The system of claim 1, wherein the ranker component uses a closed-form expression, the closed-form expression to analyze one or more plan characteristics and one or more statistics to compute multiple score components, and to compute a combined score from the multiple score components.

8. The system of claim 1, wherein the generator component and the ranker component work in tandem to narrow down a predetermined percentage of possibilities that produces an optimal plan associated with the solution.

9. The system of claim 1, wherein the system is extended via any of the following:
budget constraint either as a requirement or a preference;
multiple users with different roles collaborating in the shared workspace;
ability to book all or part of a plan provided by the solution, with several ways to book;
provision for the user to shop for and book individual components of the plan;
provision for the user to shop for and book an entire package from a travel provider;
provision for the user to request a travel agent to help with booking individual components of the plan;
provision for user to request a travel agent to help with booking the plan in entirety;
connection with suitable travel agents who can help book the plan, in part or in full;
ability to dynamically assemble the plan based on available inventory of travel products in the knowledge base;
ability for an agent to continue collaborating with the user as the user is travelling, the agent being able to track actual travel of the user and compare the actual travel with an intended plan of the user to provide alternative solutions and proposals;
provision for the user to augment the knowledge base to help with the solution;
populate the knowledge base with multiple domains of expertise; and
provision for multiple solutions in a workspace being explored and compared.

10. A method to generate an optimal travel plan, comprising:
receiving a user input that includes a travel plan;
querying a knowledge base based at least on a query that includes the user input;
generating a plurality of seeds comprising a high level sketch of a candidate travel plan;
selecting multiple seeds of the plurality of seeds that satisfy the query;
ranking the multiple selected seeds to generate multiple ranked seeds;
optimizing the multiple ranked seeds to generate multiple optimized seeds;
ranking the multiple optimized seeds; and
surfacing at least one of the multiple optimized seeds as a travel plan.

11. The method of claim 10, wherein the generating the plurality of seeds comprises generating a first seed based at least on data from a knowledge base, and generating a second seed using one or more genetic algorithm techniques.

12. The method of claim 10, wherein a seed is a candidate travel plan that includes a plurality of optimal routes that make use of a traveling salesman algorithm.

13. The method of claim 10, wherein the optimizing the multiple ranked seeds comprises identifying a commonality between candidate travel plans of a plurality of ranked seeds and sharing the commonality between the plurality of ranked seeds.

14. The method of claim 10, wherein the optimizing the multiple ranked seeds comprises making use of dynamic programming techniques.

15. The method of claim 10, wherein the optimizing the multiple ranked seeds comprises making use of simulated annealing algorithms.

16. The method of claim 10, wherein the ranking the multiple selected seeds or the ranking the multiple optimized seeds is performed by a ranker that evaluates a partially built travel plan comprising a seed.

17. The method of claim 16, wherein the ranking makes use of a closed form expression that computes multiple score components, and combines the multiple score components to generate a combined score.

18. The method of claim 17, wherein the components of the score comprise: (i) a sum of fun activities in a travel plan comprising the seed, (ii) an amount of time having fun, estimated as a weighted ratio of an amount of time spent having fun with respect to a total time in the travel plan comprising the seed, and (iii) a calculated diversity of activities factor.

19. The method of claim 18, wherein the diversity of activities factor is calculated using a variation of a Herfindal-Hirschman index.

20. A method to generate an optimal travel plan for a multi-destination trip, comprising:
receiving a user input that includes a travel plan;
querying a knowledge base based at least on the user input;
generating seeds comprising a high level sketch of a candidate travel plan, wherein each of the seeds includes an additional destination to the candidate travel plan that is absent from the received user input;
ranking the generated seeds to generate ranked seeds;
selecting a subset of selected seeds from the ranked seeds;
ranking the subset of selected seeds; and
surfacing at least one of the subset of selected seeds as at least one surfaced travel plan.
